(19) United States
(12) Patent Application Publication
(10) Pub. No.: US 2024/0005382 A1
(43) Pub. Date: Jan. 4, 2024

(54) SYSTEMS AND METHODS FOR RELOCATING PICKUP ORDERS AMONG CHAIN STORES

(71) Applicant: Radius Networks, Inc., Washington, DC (US)

(72) Inventors: Marc Wallace, Arlington, VA (US); David Helms, Arlington, VA (US); Christopher Sexton, McLean, VA (US); Kristoffer Zabala, Springfield, VA (US); Juan Carlos Avena, Overland Park, KS (US); Jamie Sawyer, Washington, DC (US); Maie Lee, Washington, DC (US); James Nebeker, Catonsville, MD (US); Timothy Judkins, Vienna, VA (US)

(21) Appl. No.: 17/856,832

(22) Filed: Jul. 1, 2022

(51) Int. Cl. G06Q 30/06; G06Q 10/08

(52) U.S. Cl. CPC G06Q 30/0635; G06Q 30/0639; G06Q 10/087

(57) ABSTRACT

Techniques for managing orders among chain stores based on a location of a pickup customer are discussed herein. In some cases, a pickup order can be relocated or a user/pickup entity can be redirected to a particular store. A pickup order to be picked up from a first store can be received from a customer. A location of a user device associated with the user or the pickup entity can be determined to be proximate to a second store. In response, a first message can be sent to the user device instructing the customer or the pickup entity to travel to the first store instead of the second store. A second message can be sent to the user device indicating that the pickup order has been relocated to the second store, and the pickup order can be sent to another computing device associated with the second store.

### BACKGROUND

A chain store is a retail outlet in which several locations share a brand, central management, and standardized business practices. They have come to dominate the retail and dining markets, and many service categories, in many parts of the world.

One brand may have multiple sites throughout a geographic area. Sometimes, a customer places a pickup order directed to one store (“correct” store or “intended” store) but unintentionally/mistakenly arrives at another store (“wrong” store). The customer may be frustrated realizing that the wrong store does not prepare her order at all. Moreover, the cost may increase if the correct store (or intended store) prepares the order while the customer goes to the wrong store.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example environment including one or more chain stores, managing computing device(s), and user device(s), in accordance with examples of the disclosure.

FIG. 2 illustrates an example environment that is usable to implement the techniques and systems described herein.

FIG. 3 illustrates a graphical user interface (GUI) in accordance with examples of the disclosure.

FIG. 4 illustrates an example process for relocating pickup orders among chain stores in accordance with examples of the disclosure.

FIG. 5 illustrates an example process for relocating pickup orders among chain stores in accordance with examples of the disclosure.

### DETAILED DESCRIPTION

This disclosure is directed to techniques for relocating pickup orders among chain stores. Chain stores can have multiple sites throughout the geographic area, where some of them can be close to each other. If a customer places an order for pickup from one store but (unintentionally) arrives at a second store, the customer can be notified that she is closer to/arrived at the “wrong” store (where their order is not prepared at all) and be informed to go to the “correct” store or “intended” store (where their order is prepared for pickup). Additionally or alternatively, the system can relocate the order and notify the customer who arrives at the “wrong” store to pick up the order at the “wrong” store instead of going to the “correct” store or “intended” store.

The techniques described herein can include receiving a pickup order associated with a customer. In some examples, the pickup order can be an online pickup order. In some examples, the pickup order can be made on the user device. In some examples, the pickup order is directed to a first store. In some examples, the first store has a first computing device associated with the first store. A location associated with the customer or a pickup entity can be determined to be proximate to a second store based on the location data associated with the user device. In some examples, the location associated with the customer or the pickup entity can be determined to be within a threshold distance to the second store. In some examples, the location data include at least one of a latitude associated with the user device, a longitude associated with the user device, an accuracy associated with the location data, a speed associated with the user device, or timestamp data associated with the location data. In some examples, the location data is updated in a predetermined period of time, in real-time, or in near real-time.

In response to determining that the location associated with the customer or the pickup entity is proximate to the second store, the system can send a first message to the user device to instruct the customer to travel to the first store instead of the second store. In some examples, the first message can be conveyed in any manner, including but not limited to a text message, web-portal, email, website, notification (e.g., a push notification, a pull notification, and the like), specific applications (“apps”), voice messages, graphical messages, video messages, or the like. In some examples, the first message can indicate a route (e.g., updated driving instructions, walking instructions, etc.) from the location associated with the customer to the first store.

Additionally or alternatively, the system can send a second message to the user device indicating that the pickup order has been relocated to the second store. The system can send the pickup order to a second computing device associated with the second store. The system can send a notification to the first computing device associated with the first store to cancel or delay the pickup order.

In some examples, the system can send a third message (e.g., before the first and second messages) to the user device indicating that the user device is proximate to the second store rather than the first store. The system can receive, from the user device, data indicative of at least one of: a confirmation that the customer or the pickup entity will travel to the first store; or a selection to relocate the order to the second store.

The system can send a rerouting instruction to the user device. In some examples, the rerouting instruction can indicate a route from the location associated with the customer or the pickup entity to the second store. In some examples, the rerouting instruction can include voice instructions, text instructions, graphical instructions, video instructions, or any combination thereof.

The techniques described herein are environment-friendly. For example, in the food industry, freshness may be important, and pickup orders prepared over a predetermined time will be thrown away if the customer who places the order does not come. By monitoring the customer/pickup entity's location and relocating the orders among stores, systems and methods discussed here can reduce food waste significantly. Thus, the cost of running the one or more stores can be saved. Moreover, the staff efficiency associated with the one or more stores can be improved because the system can relocate orders timely if the customer goes to the wrong store. Further, the user satisfaction can be improved.

The techniques described herein may be implemented in a number of ways. Example implementations are provided below with reference to the following figures. Although discussed in the context of food pickup scenarios, the methods, apparatuses, and systems described herein may be applied to a variety of scenarios (e.g., grocery pickup scenarios, pharmacy pickup scenarios, package drop-off scenarios, car rental scenarios, etc.), and are not limited to food pickup scenarios. In some instances, the techniques may be utilized in a drive-through pickup context, a curbside pickup context, an in-store pickup context, or the like.

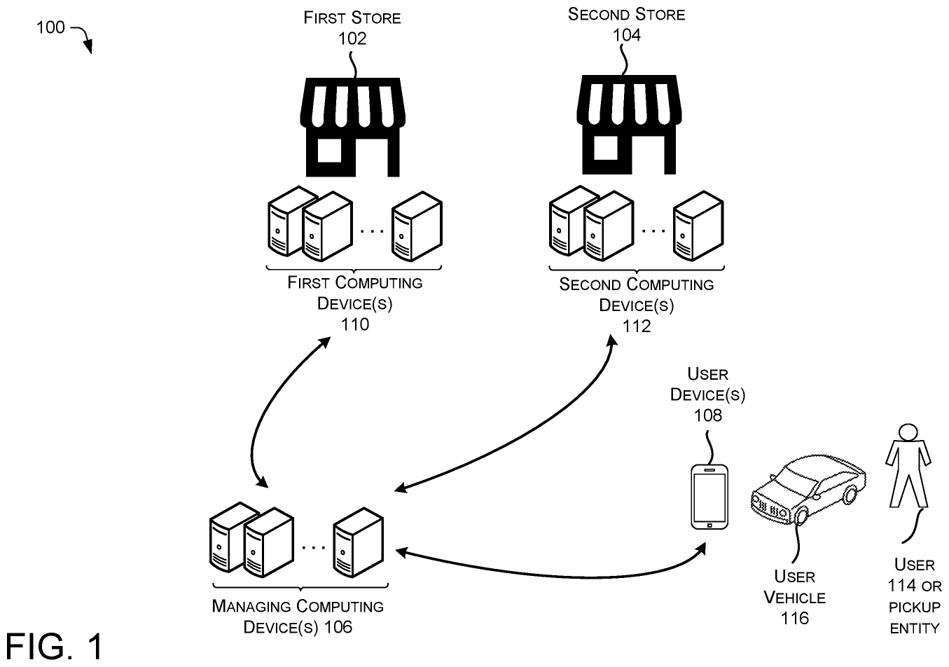

FIG. 1 illustrates an example environment 100 including one or more chain stores (e.g., the first store 102, the second store 104, or the like), managing computing device(s) 106, and user device(s) 108, in accordance with examples of the disclosure. As described herein, the chain stores may be retail stores having the same ownership (or associated with a same ownership), brand, central management, and/or standardized business practices. In some examples, the chain stores can sell the same or similar lines of goods or provide the same or similar services. For example, the chain stores may include, but are not limited to, restaurants, supermarkets, grocery stores, cosmetic stores, shopping malls, department stores, pharmacies, vehicle rental centers, and so on.

The one or more chain stores may have one or more computing devices associated with the one or more chain stores. For example, the first store 102 can have first computing device(s) 110 associated with the first store 102. The second store 104 can have second computing device(s) 112 associated with the second store 104. In some examples, the first store 102 may communicate with the managing computing device(s) 106 via the first computing device(s) 110. In some examples, the second store 104 may communicate with the managing computing device(s) 106 via the second computing device(s) 112. In some examples, the managing computing device(s) 106 may send notifications and/or instructions to the first computing device(s) 110 and the second computing device(s) 112. In some examples, the first store 102 and the second store 104 can share the same brand, owner, or authorization. Though FIG. 1 shows two stores (i.e., the first store 102 and the second store 104), it should be understood that there may be more than two stores included in the environment 100.

The computing device(s) 106 can communicate with one or more user devices 108 and/or the user vehicle 116. In some examples, user devices 108 and the user vehicle 116 can be associated with the user 114 or a third party. For example, the third party can be a pickup entity that is picking up such as delivery drivers, delivery bikers, or the like. In some examples, the user 114 can make the order and pick up the order by herself. Additionally or alternatively, the order can be made by the user 114 while the order can be picked up by the pickup entity that provides picking up and delivery services. In some examples, the managing computing device(s) 106 may receive orders (e.g., food pickup orders) from the user device(s) 108. In some examples, the user device(s) 108 may collect location data and send the location data to the managing computing device(s) 106. Additionally, or alternatively, the user vehicle 116 may collect location data and send the location data to the managing computing device(s) 106.

In some examples, the location data may include, but is not limited to, a latitude, a longitude, an accuracy, and a speed of the user device(s) 108 and/or the user vehicle 116. In some examples, the location data can be updated in a predetermined period of time, in real-time, in near real-time, etc.

In some examples, the managing computing device(s) 106 may send data/messages to the user device(s) 108 and/or the user vehicle 116 associated with the user 114. For example, the user device(s) 108 can send location data to the computing device(s) 106 (or data from which a location of the user device(s) 108 can be determined. For example, the user device(s) 108 can send location data to the managing computing device(s) 106 and the managing computing device(s) 106 can determine a location relative to one of the first store 102 or the second store 104. In some examples, the first store 102 and/or the second store 104 can be associated with a geo-fence such that the managing computing device(s) 106 can determine if the user device(s) is within a geofence area. In some examples, the user device(s) 108 can send a beacon signal to a wireless transmitter associated with the first store 102 or the second store 104, and the managing computing device(s) 106 can determine, upon receipt of an indication of the beacon signal, whether the user device(s) 108 is within a threshold distance of the first store 102 or the second store 104. Additional details are discussed throughout the disclosure.

The user vehicle 116 can include but is not limited to cars, trucks, buses, wagons, motorcycles, scooters, bicycles, boats, airplanes, helicopters, drones, or hovercrafts.

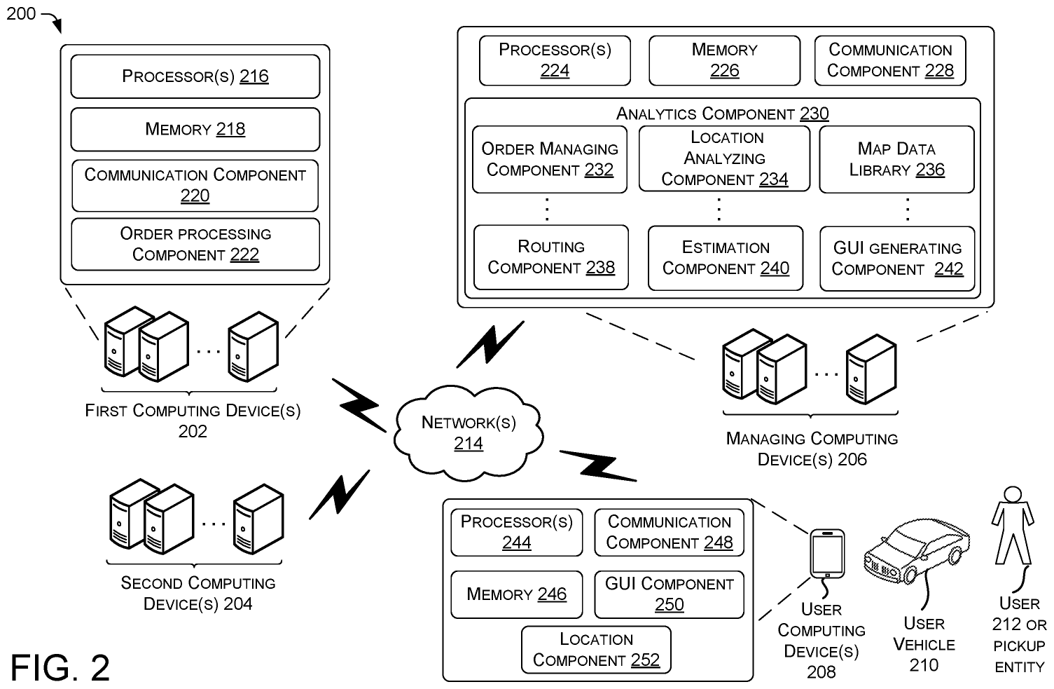

FIG. 2 illustrates an example environment 200 that is usable to implement the techniques and systems described herein. The environment 200 can include a plurality of computing devices associated with stores such as first computing device(s) 202 associated with a first store, second computing device(s) 204 associated with a second store, where the first store and the second store share the same brand, owner, or authorization. The environment 200 can also include one or more managing computing device(s) 206 that can provide processing and analytics. The environment 200 can also include one or more user computing device(s) 208 and a user vehicle 210 associated with user 212 or a third party. For example, the third party can be a pickup entity that is picking up such as delivery drivers, delivery bikers, or the like. In some examples, the user 212 can make the order and pick up the order by herself. Additionally or alternatively, the order can be made by the user 212 while the order can be picked up by the pickup entity that provides picking up and delivery services. In various examples, the first computing device(s) 202, the second computing device(s) 204, the managing computing device(s) 206, and the user computing device(s) 208 can communicate wired or wirelessly via one or more networks 214.

The managing computing device(s) 206 can also be configured to communicate alerts, reports, analytics, recommendations, instructions, graphical user interfaces, etc., to the user computing device(s) 208 and/or the user vehicle 210 associated with the user 212.

The first computing device(s) 202 can individually include, but are not limited to, any one of a variety of devices, including portable devices or stationary devices. For instance, a device can comprise a data logger, an embedded system, a programmable logic controller, a sensor, a monitoring device, a smart phone, a mobile phone, a personal digital assistant (PDA), a laptop computer, a desktop computer, a tablet computer, a portable computer, a server computer, a wearable device, or any other electronic devices. In various examples, the first computing device(s) 202 can correspond to the first computing device(s) 110 in FIG. 1.

The first computing device(s) 202 can include one or more processor(s) 216 and memory 218. The processor(s) 216 can be a single processing unit or a number of units, each of which could include multiple different processing units. The processor(s) 216 can include a microprocessor, a microcomputer, a microcontroller, a digital signal processor, a central processing unit (CPU), a graphics processing unit (GPU), a security processor, etc. Alternatively, or in addition, some or all of the techniques described herein can be performed, at least in part, by one or more hardware logic components. For example, and without limitation, illustrative types of hardware logic components that can be used include a Field-Programmable Gate Array (FPGA), an Application-Specific Integrated Circuit (ASIC), an Application-Specific Standard Products (ASSP), a state machine, a Complex Programmable Logic Device (CPLD), pulse counters, resistor/coil readers, other logic circuitry, a system on chip (SoC), and/or any other devices that perform operations based on instructions. Among other capabilities, the processor(s) 216 can be configured to fetch and execute computer-readable instructions stored in the memory 218.

The memory 218 can include one or a combination of computer-readable media. As used herein, “computer-readable media” includes computer storage media and communication media. Computer storage media includes volatile and non-volatile, removable and non-removable media implemented in any method or technology for storage of information, such as computer-readable instructions, data structures, program modules, or other data. Computer storage media includes, but is not limited to, Phase Change Memory (PRAM), Static Random-Access Memory (SRAM), Dynamic Random-Access Memory (DRAM), other types of Random-Access Memory (RAM), Read Only Memory (ROM). Electrically Erasable Programmable ROM (EEPROM), flash memory or other memory technology, Compact Disk ROM (CD-ROM), Digital Versatile Discs (DVD) or other optical storage, magnetic cassettes, magnetic tape, magnetic disk storage or other magnetic storage devices, or any other medium that can be used to store information for access by a computing device. In contrast, communication media includes computer-readable instructions, data structures, program modules, or other data in a modulated data signal, such as a carrier wave. As defined herein, computer storage media does not include communication media. In some examples, non-transitory computer-readable media does not include communication media.

The memory 218 can include an operating system configured to manage hardware and services within and coupled to a device for the benefit of other modules, components, and devices. In some examples, the first computing device(s) 202 can include one or more servers or other computing devices that operate within a network service (e.g., a cloud service), or can form a mesh network, etc.

The first computing device(s) 202 can also include a communication component 220 to communicate with other computing device(s) (e.g., in mesh network) and/or to communicate via the network(s) 214. For example, the communication component 220 can perform compression, encryption, and/or formatting of the data. In some examples, the communication component 220 can transmit data using one or more protocols or languages, such as an extensible markup language (XML), Modbus, HTTP, HTTPS, USB, etc.

The first computing device(s) 202 can also include an order processing component 222. In some examples, the order processing component 222 can receive order data from the managing computing device(s) 206 via the network(s) 214. In some examples, the order processing component 222 can receive instructions from the managing computing device(s) 206 via the network(s) 214 to prepare orders. In some examples, the order processing component 222 can receive notifications from the managing computing device(s) 206 via the network(s) 214 to cancel or delay orders. In some examples, the order processing component 222 can keep an order queue. The first store can prepare orders based on the order queue. The order processing component 222 can sort orders in the order queue based on the priority associated with the order. As such, orders with higher priorities can be in higher positions in the order queue (and will be made/prepared earlier), while orders with lower priorities can be in lower positions in the order queue (and will be made/prepared later).

In some examples, the order processing component 222 can determine the priorities of the orders based on a First-Arrived-First-Out (FAFO) rule. That is, the customer who arrives first at the store will be prioritized higher than another customer who has not yet arrived at the store. For example, a first user has a first arrival time of 9:30 am, while a second user has a second arrival time of 9:45 am. Then, the order processing component 222 can prioritize the first order associated with the first user. As such, the first order associated with the first user can have a higher priority (be in a higher position in the order queue), while a second order associated with the second user can have a lower priority (be in a lower position in the order queue). In some examples, the arrival time of the user can be an estimated arrival time (ETA). In some examples, the order processing component 222 can insert an order with an earlier ETA to usurp the order queue. For example, a second user can make a second order before a first user who makes a first order. However, a second ETA of the second user is ahead of a first ETA of the first user, and thus the second order associated with the second user is prioritized against the first order associated with the first user.

Additionally or alternatively, the order processing component 222 can determine the priorities of the orders based on the preparation time of each order. An order with a shorter preparation time can be in a lower position in the order queue, and an order with a longer preparation time can be in a higher position in the order queue. For example, a first order associated with a first user has a first preparation time of 2 minutes, while a second order associated with a second user has a second preparation time of 4 minutes. Then, the order processing component 222 can prioritize the first order. As such, the first order associated with the first user can have a higher priority (be in a higher position in the order queue), while a second order associated with the second user can have a lower priority (be in a lower position in the order queue). In some examples, the preparation time of the order can be estimated preparation time.

In some examples, the order processing component 222 can determine the priorities of the orders based on a combination of different factors. For example, a first order associated with a first user has a first estimated arrival time of 9:30 am but only takes 2 minutes to prepare, while a second order associated with a second user has a second estimated arrival time of 9:35 am but takes 4 minutes to prepare. Then the order processing component 222 can prioritize the first order associated with the first user. As another example, a first order associated with the first user has a first estimated arrival time of 9:35 am and takes 2 minutes to prepare, while a second order associated with a second user has a second estimated arrival time of 9:30 and takes 4 minutes to prepare. Then the order processing component 222 can prioritize the second order associated with the second user. As yet another example, a first order associated with the first user has a first estimated arrival time of 9:30 am and takes 2 minutes to prepare, while a second order associated with a second user has a second estimated arrival time of 9:30 and takes 4 minutes to prepare. Then the order processing component 222 can prioritize the second order associated with the second user.

In some examples, the order processing component 222 can insert anew order in the order queue when receiving the new order based on a priority associated with the new order and the priorities of other orders already in the order queue.

The second computing device(s) 204 associated with the second store can have similar components as those of the first computing device(s) 202. Details are not repeated here.

The managing computing device(s) 206 can include one or more processor(s) 224, a memory 226, and a communication component 228, each of which can be implemented similar to the processor(s) 216, the memory 218, and/or the communication component 220 of the first computing device(s) 202.

In some examples, the managing computing device(s) 206 can include an analytics component 230, including one or components such as an order managing component 232, a location analyzing component 234, a map data library 236, a routing component 238, an estimation component 240, and a graphical user interface (GUI) generating component 242.

The analytics component 230 can receive order data from the first computing device(s) 202 and/or the second computing device(s) 204, and can store the order data in the order managing component 232. In some examples, the order data may include data indicative of item data (which may indicate items ordered by the user, e.g., tacos, burritos, salads, or the like), combo data (which may indicate combos ordered by the user, e.g., bowl combo, cheese quesadilla combo, breakfast combo, or the like), ingredient data (which may indicate ingredients ordered by the user, e.g., rice, beans, chicken, steak, pulled pork, lettuce, pico de gallo, sour cream, or the like), preference data (which may indicate preferences associated with the user, e.g., sweet, sour, salty, bitter, savory preferences, or the like), food allergy data (which may indicate food allergies associated with the user, e.g., gluten allergy, peanut allergy, seafood allergy, or the like), discount data (which may indicate the discount information associated with the user, e.g., promo codes, coupons, credits, or the like), membership data (which may indicate membership information associated with the user), payment data (which may indicate payment information associated with the user, such as debit card information, credit card information, PayPal information, check information, or the like) associated with the user 212, or the like. In some examples, the order managing component 232 can store the timestamp data associated with the order data input from the first computing device(s) 202 and/or the second computing device(s) 204.

In some examples, the analytics component 230 can receive location data from the user computing device(s) 208 and/or the user vehicle 210. In some examples, the analytics component 230 can store the location data in the location analyzing component 234. In some examples, the location data can indicate the location of the user computing device(s) 208 and/or the user vehicle 210 associated with the user 212 or the pickup entity. In some examples, the location data can include Global Positioning System (GPS) data, sensor data, cellular location data (e.g., base station data or the like), indoor positioning data (e.g., WIFI beacon data, Bluetooth beacon data, or the like), mobile phone application data that share a user's location (e.g., a fitness app that monitors the user's steps and locations), and so on. In some examples, the location data can include a latitude associated with the user computing device 208 (or the user vehicle 210), a longitude associated with the user computing device 208 (or the user vehicle 210), an accuracy associated with location data, a speed associated with the user computing device 208 (or the user vehicle 210), or timestamp data associated with the location data. In some examples, the location data can be updated in a predetermined period of time, in real-time, in near real-time, etc.

The analytics component 230 can include a map data library 236 which includes map data. In some examples, the map data can include land boundary data of roads (e.g., streets, freeways, highways, bridges, or the like), buildings (e.g., houses, hotels, hospitals, offices, or the like), facilities (e.g., parking lots, gas stations, churches, libraries, or the like), green spaces (e.g., parks, gardens, woods, or the like), waters (e.g., rivers, lakes, seas, or the like), and so on. In some embodiments, the map data can include, but is not limited to, imagery data, terrain data, latitude and longitude coordinates, transit data, traffic data, or the like. In some examples, the analytics component 230 can determine, using the location analyzing component 234, whether the location associated with the user computing device(s) 208 and/or the user vehicle 210 is within a threshold distance to one or more stores based on the location data and the map data. For example, the user device(s) 208 can send location data to the computing device(s) 206 (or data from which a location of the user device(s) 208 can be determined. For example, the user device(s) 208 can send location data to the managing computing device(s) 206 and the managing computing device(s) 206 can determine a location relative to one of the first store or the second store.

In some examples, the first store and/or the second store can be associated with a geofence area such that the managing computing device(s) 206 can determine if the user device(s) 208 are within the geofence area. As described herein, a geofence can represent a virtual perimeter for a real-world geographic area. A geofence could be dynamically generated or match a predefined set of boundaries. The use of a geofence is called geofencing, and one example of use involves a location-aware device of a location-based service user entering or exiting a geofence.

In some examples, the user device(s) 208 can send a beacon signal to a wireless transmitter associated with the first store or the second store, and the managing computing device(s) 206 can determine, upon receipt of an indication of the beacon signal, whether the user device(s) 208 is within a threshold distance of the first store or the second store. For example, the threshold distance can be 250 meters. In some examples, the analytics component 230 can determine, using the location analyzing component 234, whether the speed associated with the user computing device(s) 208 and/or the user vehicle 210 is less than a speed threshold. For example, the speed threshold can be 5 m/s, 18 kph, or 11.1847 mph. Additional details are discussed throughout the disclosure.

The analytics component 230 can include a routing component 238. In some examples, the routing component 238 can be configured to determine routes from one location to another location. For example, the routing component 238 can determine routes from the user 212's location to one or more stores based on the location data and/or the map data. In some examples, the routing component 238 can be configured to determine routes based on different requirements such as the shortest travel distance, the shortest travel time, the lowest traffic, or the like

The analytics component 230 can include an estimation component 240. In some examples, the estimation component 240 can be configured to determine an estimated arrival time of the user 212 or the pickup entity at least based on the location data, the map data, or the like. In some examples, the estimated arrival time can be indicative of a time the customer will arrive at the second store (wrong store). In some examples, the estimated arrival time can be indicative of a time the customer will arrive at the first store (correct store or intended store). In some examples, the estimation component 240 can be configured to determine an estimated preparation time for preparing the pickup order. In some examples, the estimated preparation time can be determined based on the volume of the order, the busyness of the store, etc.

In some examples, the estimation component 240 can determine a probability or confidence level associated with the user 212 or the pickup entity traveling to a first store, a second store, and the like. For example, the estimation component 240 can determine that there is a first probability that the user 212 or the pickup entity is traveling to the first store 102 and a second probability that the user 212 or the pickup entity is traveling to the second store 104. If the user 212 has placed an order to be picked up at the first store 102 but the second probability is above a threshold (or the first probability is below a threshold) the estimation component 240 can trigger actions and/or messages to the user device(s) 208 and/or the devices 202, 204, and/or 206 to relocate the user or the pickup entity and/or relocate the pickup order. Additional details are discussed throughout the disclosure.

The analytics component 230 can include a GUI generating component 242 which is configured to generate data to be displayed via GUIs. The analytics component 230 may send the data to be displayed to the user computing device(s) 208 and/or the user vehicle 210 via the network(s) 214. In some examples, the data to be displayed may include information indicating a state of the order (e.g., processing, preparing, ready, or the like), locations of various stores, the location associated with the user computing device(s) 208 (or the user vehicle 210), and so on. In some examples, the location of the user computing device(s) 208 or the user vehicle 210 associated with the user 212 or the pickup entity can be updated in a predetermined period of time, in real-time, in near real-time, etc. In some examples, the data to be displayed may include the distance from the location associated with the user computing device(s) 208 or the user vehicle 210 associated with the user 212 or the pickup entity to one or more stores such as the first store and the second store, the estimated time from the location associated with the user computing device(s) 208 or the user vehicle 210 associated with the user 212 or the pickup entity to one or more stores, the estimated preparation time of the order, or the like.

In some examples, the GUI generating component 242 can also be configured to generate one or more messages/alerts. As can be understood in the context of this disclosure, messages/alerts can be conveyed in any manner, including but not limited to a text message, web-portal, email, website, push notification, pull notification, specific applications (“apps”), voice messages, graphical messages, video messages, or the like. In some examples, the messages/alerts may indicate that the user computing device(s) 208 or the user vehicle 210 associated with the user 212 or the pickup entity is proximate to the wrong location (wrong store). For example, the user 212 may make an order directed to the first store, and the analytics component 230 determines that the user computing device(s) 208 or the user vehicle 210 associated with the user 212 or the pickup entity is proximate to the second store based on the location data and the map data. Then, the analytics component 230 can generate, via the GUI generating component 242, a message/alert indicating that the user 212 (or the user vehicle 210) is proximate to a wrong location (wrong store). The GUI generating component 242 can also generate instructions regarding how to reroute from the location associated with the user computing device(s) 208 (or the user vehicle 210) to the second store. In some examples, the instructions can include voice instructions, text instructions, graphical instructions, video instructions, or any combination thereof.

The user computing device(s) 208 can include one or more processor(s) 244, a memory 246, and a communication component 248, each of which can be implemented similar to the processor(s) 216, the memory 218, and/or the communication component 248 of the first computing device(s) 202.

The user computing device(s) 208 can also include a GUI component 250 to display or otherwise present graphical user interfaces at the user computing device(s) 208 (or the user vehicle 210). In some examples, the user computing device(s) 208 can receive the data to be displayed from the managing computing device(s) 206 via the network(s) 214. In some examples, the GUI component 250 may display information indicating a state of the order (e.g., processing, preparing, ready, or the like), locations of various stores, the location associated with the user computing device(s) 208 (or the user vehicle 210), and so on. In some examples, the data to be displayed may include the distance from the location associated with the user 212 (or the user vehicle 210) to one or more stores such as the first store and the second store. In some examples, the GUI component 250 may display messages/alerts indicating that the user computing device(s) 208 or the user vehicle 210 associated with the user 212 or the pickup entity is proximate to a wrong location (wrong store).

In some examples, the GUI component 250 can display a message indicating that the user computing device(s) 208 is proximate to the second store rather than the first store. The GUI component 250 can present options such as a first option for the user 212 or the pickup entity to travel to the first store, a second option to relocate the order to the second store. The GUI component 250 can receive data indicative of which option is selected by the user 212 or the pickup entity. In some instances, the GUI component 250 can display rerouting information based on the option made by the user 212 or the pickup entity. In some examples, the GUI component 250 can send a default instruction to the user 212 or the pickup entity (e.g., without presenting a selectable option) based on details of the order (e.g., preparation status, ingredients, etc.), details of the route (e.g., distance between the first and second stores, vehicle traffic travel time associated with the first store or the second store), user profile data (e.g., user history arriving at the wrong store), and the like. In some examples, the GUI component 250 can display instructions regarding how to reroute from the location associated with the user computing device(s) 208 (or the user vehicle 210) to the first store (correct store or intended store). Additionally or alternatively, the GUI component 250 can display instructions regarding how to reroute from the location associated with the user computing device(s) 208 (or the user vehicle 210) to the second store (wrong store) instead of going back to the first store (correct store or intended store).

The user computing device(s) 208 can also include a location component 252 to collect location data associated with the user computing device(s) 208. In some examples, the location data can include Global Positioning System (GPS) data, sensor data, cellular location data (e.g., base station data or the like), indoor positioning data (e.g., WIFI beacon data, Bluetooth beacon data, or the like), mobile phone application data that share a user's location (e.g., a fitness app that monitors the user's steps and locations), and so on. In some examples, the location data can include a latitude associated with the user computing device 208, a longitude associated with the user computing device 208, an accuracy associated with location data, a speed associated with the user computing device, or timestamp data associated with the location data. In some examples, the location data can be updated in a predetermined period of time, in real-time, in near real-time, etc.

The environment 200 also includes the user 212 who can employ the user computing device(s) 208 and the user vehicle 210. In some examples, the user vehicle 210 can have similar functions discussed with respect to the user computing device(s) 208. In some examples, the user 212 or the pickup entity can interact with the user computing device(s) 208 to perform a variety of operations. In some examples, the user 212 can make orders (e.g., food pickup orders) via the user computing device(s) 208. In some examples, the user 212 or the pickup entity can review the information displayed via the user computing device(s) 208. In some examples, the user 212 or the pickup entity can review the location data indicating the location of the user 212 (or the user vehicle 210). In some examples, the location of the user computing device(s) 208 (or the user vehicle 210) can be updated in a predetermined period of time, in real-time, in near real-time, etc. In some examples, the user 212 or the pickup entity can review the messages/alerts displayed via the user computing device(s) 208 (or the user vehicle 210) and follow the instructions to reroute from the location associated with the user computing device(s) 208 (or the user vehicle 210) to the first store (correct store or intended store). Additionally or alternatively, the user 212 or the pickup entity can review the messages/alerts displayed via the user computing device(s) 208 (or the user vehicle 210) and follow the instructions to reroute from the location associated with the user computing device(s) 208 (or the user vehicle 210) to the second store (wrong store) instead of going back to the first store (correct store or intended store). In some examples, the instructions can include voice instructions, text instructions, graphical instructions, video instructions, or any combination thereof.

The network(s) 214 can include the Internet, a Mobile Telephone Network (MTN), Wi-Fi, a cellular network, a mesh network, a Local Area Network (LAN), a Wide Area Network (WAN), a Virtual LAN (VLAN), a private network, and/or other various wired or wireless communication technologies.

The operations of the first computing device(s) 202, the second computing device(s) 204, the managing computing devices(s) 206, and the user computing device(s) 208 are further provided in connection with the various figures of this disclosure. Further, any of the functions or operations provided by one component can be provided by any other component discussed herein. That is, features of the managing computing device(s) 206 can be provided by the first computing device(s) 202 and the second computing device(s) 204, and/or the user computing device(s) 208 (or the user vehicle 210), and vice versa. For example, the first computing device(s) 202 and the second computing device(s) 204 can also have analytic components to perform similar operations discussed with regard to managing computing device(s) 206.

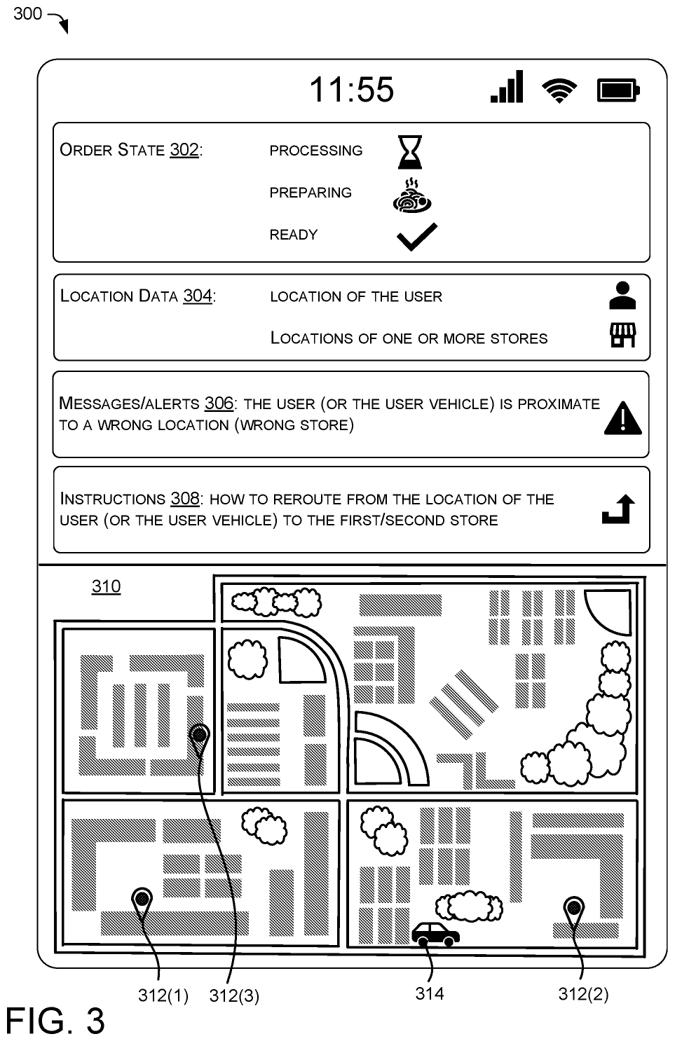

FIG. 3 illustrates a graphical user interface (GUI) 300 in accordance with examples of the disclosure. In various examples, GUI 300 can be displayed via the user device(s) 108 in FIG. 1, the user vehicle 116 in FIG. 1, the user computing device(s) 208 in FIG. 2, and/or the user vehicle 210 in FIG. 2.

The GUI 300 can be displayed via user device(s) such as the user device(s) 108 of FIG. 1, the user device(s) 208 of FIG. 2, or the like. As can be understood in the context of this disclosure, reports and/or alerts can be conveyed in any manner, including but not limited to a text message, web-portal, email, website, push notification, pull notification, specific applications (“apps”), or the like.

The GUI 300 can illustrate an order state 302 indicating various states of the order, such as processing (indicating that the order is in process), preparing (indicating that the order is under preparation), and ready (indicating that the order is ready). It should be understood that the GUI 300 can include other order states such as error, canceled, delayed, and so on.

The GUI 300 can illustrate location data 304 indicating the location associated with the user computing device (or the user vehicle) and/or locations of one or more stores. In some embodiments, the location data 304 can include a latitude associated with the user computing device 208 (or the user vehicle 210), a longitude associated with the user computing device 208 (or the user vehicle 210), an accuracy associated with location data, a speed associated with the user computing device 208 (or the user vehicle 210), or timestamp data associated with the location data. In some examples, the location data can be updated in a predetermined period of time, in real-time, in near real-time, etc.

The GUI 300 can illustrate messages/alerts 306. As can be understood in the context of this disclosure, messages/alerts 306 can be conveyed in any manner, including but not limited to a text message, web-portal, email, website, push notification, pull notification, specific applications (“apps”), voice messages, graphical messages, video messages, or the like. For example, the user may make an order directed to a first store, and then the user (or the user vehicle) goes to a second store. The messages/alerts 306 can indicate that the user (or the user vehicle) is proximate to a wrong location (wrong store).

The GUI 300 can illustrate instructions 308. In some embodiments, the instructions 308 can indicate how to reroute from the location associated with the user computing device (or the user vehicle) to the first store (correct store or intended store). In some embodiments, the instructions 308 can indicate how to reroute from the location associated with the user computing device (or the user vehicle) to the second store (wrong store) instead of going back to the first store (correct store or intended store). In some examples, the instructions 308 can include voice instructions, text instructions, graphical instructions, video instructions, or any combination thereof.

The GUI 300 can illustrate one or more graphs 310 reflecting the locations of one or more stores 312 and the location 314 associated with the user computing device (or the user vehicle). For example, the GUI 300 shows a first location of a first store 312(1), a second location of a second store 312(2), a third location of a third store 312(3), and a location 314 of a user vehicle. For example, the user can make an order directed to the first store 312(1), and then the user (or the user vehicle) goes to the second store. The one or more graphs can show that the user (or the user vehicle) goes proximate to the second store 312(2) (wrong location).

As can be understood in the context of this disclosure, any date and/or time period can be selected via the GUI 300, causing the GUI 300 to dynamically update the information displayed. In this manner, the GUI 300 may provide a personalized user interface illustrating information specified by and relevant to the user. Thus, the GUI 300 provides a simple overview of the order pickup process that allows the user to reroute to a different store when the user deviates from the store her order was directed. Time can be saved because the user does not need to go back to the “correct” store or “intended” store (e.g., the first store 312(1)). Moreover, the staff efficiency associated with the one or more stores can be improved because the system can relocate orders if the customer goes to a wrong store. Further, the user satisfaction can be improved because even if the user goes to the “wrong” store (e.g., the second store 312(2)), the system can instruct the wrong store to prepare the order for the user.

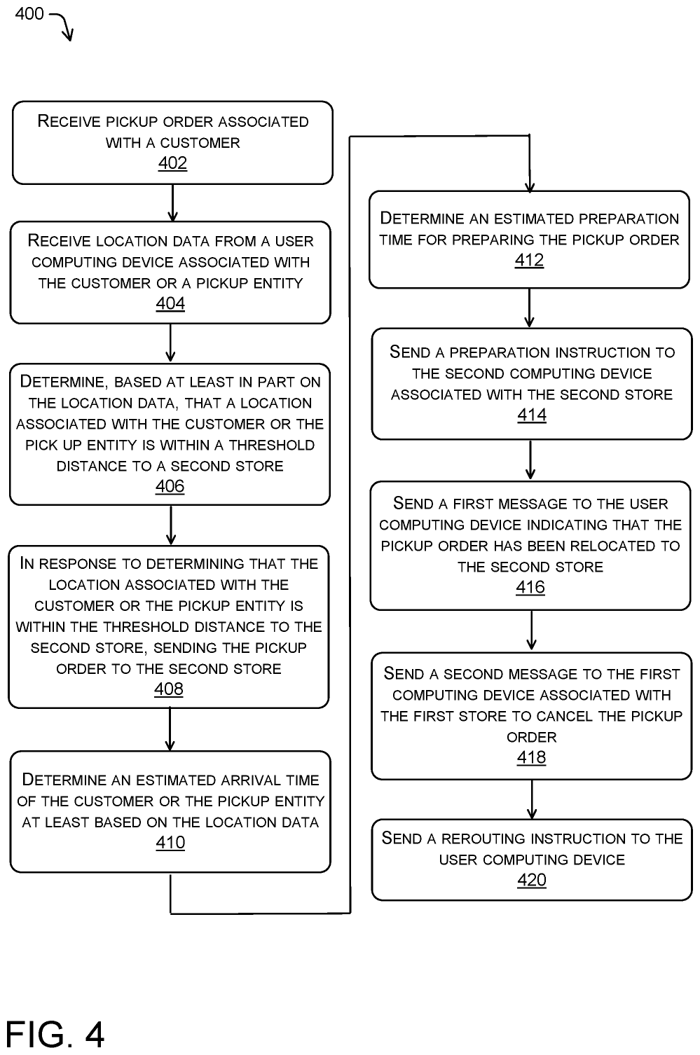

FIG. 4 illustrates an example process 400 for relocating pickup orders among chain stores in accordance with examples of the disclosure. In some examples, at least some operations of the process 400 may be performed by the first computing device(s) 110 in FIG. 1, the second computing device(s) 112 in FIG. 1, the managing computing device(s) 106 in FIG. 1, the user device(s) 108 in FIG. 1, the user vehicle 116 in FIG. 1, the first computing device(s) 202 in FIG. 2, the second computing device(s) 204 in FIG. 2, the managing computing device(s) 206 in FIG. 2, the user device(s) 208 in FIG. 2, the user vehicle 210, as described herein.

At 402, operations may include receiving a pickup order associated with a customer. In some examples, the pickup order can be an online pickup order. In some examples, the pickup order can be made on the user device. In some examples, the pickup order is directed to a first store. In some examples, the first store has a first computing device associated with the first store.

At 404, operations may include receiving location data from a user computing device associated with the customer or a pickup entity. In some examples, the location data include at least one of a latitude associated with the user computing device, a longitude associated with the user computing device, an accuracy associated with the location data, a speed associated with the user computing device, or timestamp data associated with the location data. In some examples, the location data is updated in a predetermined period of time, in real-time, or in near real-time.

At 406, operations may include determining, based at least in part on the location data, that a location associated with the customer or the pickup entity is within a threshold distance to a second store (or within a geofence associated with a second store). For example, the threshold distance can be 250 meters. In some examples, the second store has a second computing device associated with the second store. In some examples, the first store and the second store can share the same brand, owner, or authorization. Though two stores (i.e., the first store and the second store) are discussed here, it should be understood that there may be more than two stores involved in the process 400.

At 408, operations may include in response to determining that the location associated with the customer or the pickup entity is within the threshold distance to the second store, sending the pickup order to the second store. In some examples, the threshold distance can be determined as a fixed value, such as 250 meters, although any value can be used. In some examples, the threshold can be based on machine learning or heuristics such as user profile data (e.g., previous instances where the customer went to the wrong store may increase or decrease the threshold), a level of activity at the store (e.g., a store with many orders may increase or decrease the threshold distance), a content of an order (e.g., a relatively complex or expensive order, or one associated with many perishable items or low inventory may cause the threshold to be increased or decreased), etc. Additional examples are discussed throughout this disclosure.

At 410, operations may include determining an estimated arrival time of the customer or the pickup entity at least based on the location data. In some examples, the estimated arrival time is indicative of a time the customer or the pickup entity will arrive at the second store. In some examples, the estimated arrival time of the customer is determined further based on the speed associated with the user device, map data, traffic data, historical data, and the like.

At 412, operations may include determining an estimated preparation time for preparing the pickup order. In some examples, the estimated preparation time can be determined based on the volume of the order, the busyness of the store (e.g., number of orders in an order preparation queue relative to a store throughput or utilization rate, wait time for customers after arriving, etc.), etc.

At 414, operations may include sending a preparation instruction to the second computing device associated with the second store. In some examples, the preparation instruction instructs the second store to start preparing the pickup order at least based on the estimated arrival time and the estimated preparation time. In some examples, orders can be associated with priorities and listed in an order queue based on the priorities. As such, orders with higher priorities can be made/prepared earlier, while orders with lower priorities can be made/prepared later.

In some examples, the priorities of the orders can be determined based on a First-Arrived-First-Out (FAFO) rule. That is, the customer who arrives first at the store will be prioritized higher than another customer who has not yet been at the store. For example, a first user has a first estimated arrival time of 9:30 am, while a second user has a second estimated arrival time of 9:45 am. Then, the first order associated with the first user can be prioritized. As such, the first order associated with the first user can be in a higher position in the order queue, while a second order associated with the second user can be in a lower position in the order queue.

Additionally or alternatively, the priorities of the orders can be determined based on the estimated preparation time of each order. An order with a shorter estimated preparation time can be in a lower position in the order queue, and an order with a longer estimated preparation time can be in a higher position in the order queue. For example, a first order associated with a first user has a first estimated preparation time of 2 minutes, while a second order associated with a second user has a second estimated preparation time of 4 minutes. Then, the first order can be prioritized. As such, the first order associated with the first user can be in a higher position in the order queue, while a second order associated with the second user can be in a higher position in the order queue.

In some examples, the priorities of the orders can be determined based on a combination of different factors. For example, a first order associated with a first user has a first estimated arrival time of 9:30 am but only takes 2 minutes to prepare, while a second order associated with a second user has a second estimated arrival time of 9:35 am but takes 4 minutes to prepare. Then the first order associated with the first user can be prioritized. As another example, a first order associated with the first user has a first estimated arrival time of 9:35 am and takes 2 minutes to prepare, while a second order associated with a second user has a second estimated arrival time of 9:30 and takes 4 minutes to prepare. Then the second order associated with the second user can be prioritized. As yet another example, a first order associated with the first user has a first estimated arrival time of 9:30 am and takes 2 minutes to prepare, while a second order associated with a second user has a second estimated arrival time of 9:30 and takes 4 minutes to prepare. Then the second order associated with the second user can be prioritized.

In some examples, a new order can be inserted into the order queue based on a priority associated with the new order and the priorities of other orders already in the order queue.

At 416, operations may include sending a first message to the user computing device indicating that the pickup order has been relocated to the second store. In some examples, the first message can be conveyed in any manner, including but not limited to a text message, web-portal, email, website, notification, specific applications (“apps”), voice messages, graphical messages, video messages, or the like.

At 418, operations may include sending a second message to the first computing device associated with the first store to cancel the pickup order. Additionally or alternatively, the notice may notify the first store to delay the pickup order.

At 420, operations may include sending a rerouting instruction to the user computing device. In some embodiments, the instruction can indicate how to reroute from the location associated with the customer to the first store (correct store or intended store). In some examples, the rerouting instruction can indicate a route from the location associated with the customer or the pickup entity to the second store (wrong store). In some examples, the rerouting instruction can include voice instructions, text instructions, graphical instructions, video instructions, or any combination thereof.

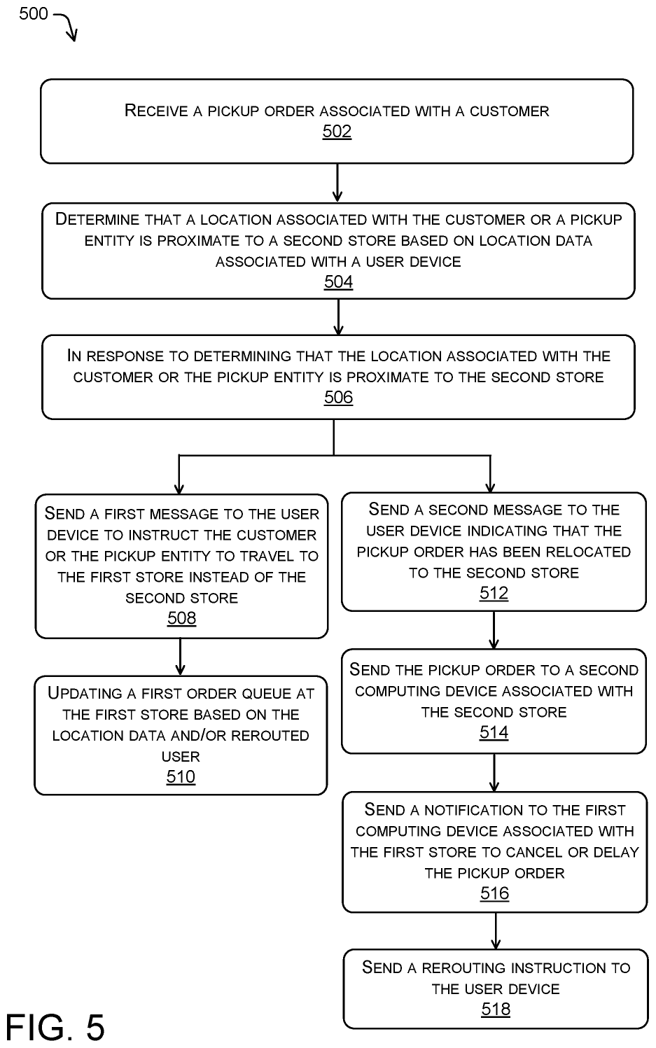

FIG. 5 illustrates an example process 50) for relocating pickup orders among chain stores in accordance with examples of the disclosure. In some examples, at least some operations of the process 500 may be performed by the first computing device(s) 110 in FIG. 1, the second computing device(s) 112 in FIG. 1, the managing computing device(s) 106 in FIG. 1, the user device(s) 108 in FIG. 1, the user vehicle 116 in FIG. 1, the first computing device(s) 202 in FIG. 2, the second computing device(s) 204 in FIG. 2, the managing computing device(s) 206 in FIG. 2, the user device(s) 208 in FIG. 2, the user vehicle 210, as described herein.

At 502, operations may include receiving a pickup order associated with a customer. In some examples, the pickup order can be made on a user device. In some examples, the pickup order can be an online pickup order. In some examples, the pickup order is directed to a first store. In some examples, the first store has a first computing device associated with the first store.

At 504, operations may include determining that a location associated with the customer or a pickup entity is proximate to a second store based on location data associated with a user device. In some examples, determining that the location associated with the customer or the pickup entity is proximate to the second store comprises determining that the location associated with the customer is within a threshold distance to the second store. In some examples, the location data include at least one of a latitude associated with the user device, a longitude associated with the user device, an accuracy associated with the location data, a speed associated with the user device, or timestamp data associated with the location data. In some examples, the location data is updated in a predetermined period of time, in real-time, or in near real-time.

At 506, operations may include, in response to determining that the location associated with the customer or the pickup entity is proximate to the second store, performing branches starting from 508 or 512. In some examples, the second store has a second computing device associated with the second store. In some examples, the first store and the second store can share the same brand, owner, or authorization. Though two stores (i.e., the first store and the second store) are discussed here, it should be understood that there may be more than two stores involved in the process 500.

At 508, operations may include sending a first message to the user device to instruct the customer or the pickup entity to travel to the first store instead of the second store. In some examples, the first message can be conveyed in any manner, including but not limited to a text message, web-portal, email, website, notification, specific applications (“apps”), voice messages, graphical messages, video messages, or the like. In some examples, the first message can indicate a route from the location associated with the customer to the first store.

At 510, operations may include updating the order queue at the first store based on the location data and/or rerouted user/pickup entity. In some examples, if the user is rerouted back to the first store (correct store or intended store), the first order queue at the first store can be updated such that the order associated with the user is to be prepared at the first store based on the estimated arrival time and the estimated preparation time.

At 512, operations may include sending a second message to the user device indicating that the pickup order has been relocated to the second store. In some examples, the operations may further include sending a third message to the user computing device indicating that the user computing device is proximate to the second store rather than the first store; and receiving, from the user computing device, data indicative of at least one of: a confirmation that the customer or the pickup entity will travel to the first store; or a selection to relocate the order to the second store. In some examples, the third message may be sent prior to the first and/or second messages. In some examples, the first or second message can be sent in response to the confirmation or the selection.

At 514, operations may include sending the pickup order to a second computing device associated with the second store. In some examples, when the user is rerouted to the second store (wrong store) without going back to the first store (correct store or intended store), a second order queue at the second store can be updated to insert the order associated with the user into the first order queue based on the priority of the order. Additional details regarding how to manage the order queue are given throughout this disclosure.

At 516, operations may include sending a notification to the first computing device associated with the first store to cancel or delay the pickup order. In some examples, the first store may have started preparing a portion of the order when receiving the notification. In such a case, the first store can scan the first order queue to see if the prepared portion can be used to fulfill another order (in full or in part) in the first order queue. As such, time and resources can be saved, while cost and waste can be reduced.

At 518, operations may include sending a rerouting instruction to the user device. In some examples, the rerouting instruction can indicate a route from the location associated with the customer or the pickup entity to the second store. In some examples, the rerouting instruction can include voice instructions, text instructions, graphical instructions, video instructions, or any combination thereof.

In some examples, the process 500 can further include inserting the pickup order into an order list based on the priority. In some examples, the pickup order is associated with a priority. One or more stores can prepare the orders based on the order list.

The techniques discussed above can be implemented in hardware, software, or a combination thereof. In the context of software, operations represent computer-executable instructions stored on one or more computer-readable storage media that, when executed by one or more processors, configure a device to perform the recited operations. Generally, computer-executable instructions include routines, programs, objects, components, data structures, or the like that perform particular functions or implement particular abstract data types.

### CONCLUSION

While one or more examples of the techniques described herein have been described, various alterations, additions, permutations, and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes, or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

### EXAMPLE CLAUSES

A: A system comprising: one or more processors; and one or more non-transitory computer-readable media storing instructions executable by the one or more processors, wherein the instructions, when executed, cause the system to perform operations comprising: receiving a pickup order associated with a customer, the pickup order being directed to a first store, the first store having a first computing device associated with the first store; associating the pickup order with a user computing device associated with the customer or a pickup entity; receiving location data from the user computing device; determining, based at least in part on the location data, that a location associated with the customer or the pickup entity is within a threshold distance to a second store, the second store having a second computing device associated with the second store; in response to determining that the location associated with the customer or the pickup entity is within the threshold distance to the second store, sending the pickup order to the second store; determining an estimated arrival time of the customer or the pickup entity at least based on the location data, the estimated arrival time being indicative of a time the customer or the pickup entity will arrive at the second store; determining an estimated preparation time for preparing the pickup order; sending a preparation instruction to the second computing device associated with the second store, the preparation instruction instructing the second store to start preparing the pickup order at least based on the estimated arrival time and the estimated preparation time; sending a first message to the user computing device indicating that the pickup order has been relocated to the second store; and sending a second message to the first computing device associated with the first store to cancel the pickup order.

B: The system of paragraph A, the operations further comprising sending a rerouting instruction to the user computing device, the rerouting instruction indicating a route from the location associated with the customer or the pickup entity to the second store.

C: The system of either paragraph A or B, wherein the location data include at least one of a latitude associated with the user computing device, a longitude associated with the user computing device, an accuracy associated with the location data, a speed associated with the user computing device, or timestamp data associated with the location data.

D: The system of any one of paragraphs A-C, wherein the pickup order is associated with a priority.

E: The system of any one of paragraphs A-D, the operations further comprising updating the location data in at least one of a predetermined period of time, in real-time, or in near real-time.

F: A method comprising: receiving a pickup order associated with a customer, the pickup order being directed to a first store; associating the pickup order with a computing device; determining that a location associated with the customer or a pickup entity is proximate to a second store based on location data associated with the computing device; and in response to determining that the location associated with the customer or the pickup entity is proximate to the second store at least one of: sending a first message to the computing device to instruct the customer or the pickup entity to travel to the first store instead of the second store; or sending a second message to the computing device indicating that the pickup order has been relocated to the second store, and sending the pickup order to a second computing device associated with the second store.

G: The method of paragraph F, wherein determining that the location associated with the customer or the pickup entity is proximate to the second store comprises determining that the location associated with the customer or the pickup entity is within a threshold distance to the second store.

H: The method of either paragraph F or G, wherein the location data include at least one of a latitude associated with the computer device, a longitude associated with the computer device, an accuracy associated with the location data, a speed associated with the computer device, or timestamp data associated with the location data.

I: The method of paragraph H, wherein determining that the location associated with the customer or the pickup entity is proximate to the second store comprises determining that the speed associated with the computing device is less than a speed threshold.

J: The method of any one of paragraphs F-I, further comprising: sending a third message to the computing device indicating that the computing device is proximate to the second store rather than the first store; and receiving, from the computing device, data indicative of at least one of: a confirmation that the customer or the pickup entity will travel to the first store; or a selection to relocate the order to the second store.

K The method of any one of paragraphs F-J, further comprising sending a notification to the first computing device associated with the first store to cancel or delay the pickup order.

L: The method of any one of paragraphs F-K, further comprising sending a rerouting instruction to the computing device, the rerouting instruction indicating a route from the location associated with the customer or the pickup entity to the second store.

M: The method of any one of paragraphs F-L, wherein the pickup order is associated with a priority, the method further comprising: inserting the pickup order into an order queue based on the priority.

N: One or more non-transitory computer-readable media storing instructions that, when executed by one or more processors, cause one or more computing devices to perform operations comprising: receiving a pickup order associated with a customer, the pickup order being directed to a first store; associating the pickup order with a computing device; determining that a location associated with the customer or a pickup entity is proximate to a second store based on location data associated with the computing device; and in response to determining that the location associated with the customer or the pickup entity is proximate to the second store at least one of: sending a first message to the computing device to instruct the customer or the pickup entity to travel to the first store instead of the second store; or sending a second message to the computing device indicating that the pickup order has been relocated to the second store, and sending the pickup order to a second computing device associated with the second store.

O: The one or more non-transitory computer-readable media of paragraph N, determining that the location associated with the customer or the pickup entity is proximate to the second store comprises determining that the location associated with the customer or the pickup entity is within a threshold distance to the second store.

P: The one or more non-transitory computer-readable media of either paragraph N or O, wherein the location data include at least one of a latitude associated with the computing device, a longitude associated with the computing device, an accuracy associated with the location data, a speed associated with the computing device, or timestamp data associated with the location data.

Q: The one or more non-transitory computer-readable media of paragraph P, wherein determining that the location associated with the customer or the pickup entity is proximate to the second store comprises determining that the speed associated with the computing device is less than a speed threshold.

R: The one or more non-transitory computer-readable media of any one of paragraphs N-Q, the operations further comprising updating the location data in at least one of a predetermined period of time, in real-time, or in near real-time.

S: The one or more non-transitory computer-readable media of any one of paragraphs N-R, the operations further comprising: sending a third message to the computing device indicating that the computing device is proximate to the second store rather than the first store; and receiving, from the computing device, data indicative of at least one of: a confirmation that the customer or the pickup entity will travel to the first store; or a selection to relocate the order to the second store.

T: The one or more non-transitory computer-readable media of any one of paragraphs N-S, the operations further comprising sending a rerouting instruction to the computing device, the rerouting instruction indicating a route from the location associated with the customer or the pickup entity to the second store.

While the example clauses described above are described with respect to particular implementations, it should be understood that, in the context of this document, the content of the example clauses can be implemented via a method, device, system, a computer-readable medium, and/or another implementation. Additionally, any of examples A-T may be implemented alone or in combination with any other one or more of the examples A-T.

What is claimed is:

1. A system comprising:
one or more processors; and
one or more non-transitory computer-readable media storing instructions executable by the one or more processors, wherein the instructions, when executed, cause the system to perform operations comprising:
receiving a pickup order associated with a customer, the pickup order being directed to a first store, the first store having a first computing device associated with the first store;
associating the pickup order with a user computing device associated with the customer or a pickup entity;
receiving location data from the user computing device;
determining, based at least in part on the location data, that a location associated with the customer or the pickup entity is within a threshold distance to a second store, the second store having a second computing device associated with the second store;
in response to determining that the location associated with the customer or the pickup entity is within the threshold distance to the second store, sending the pickup order to the second store;
determining an estimated arrival time of the customer or the pickup entity at least based on the location data, the estimated arrival time being indicative of a time the customer or the pickup entity will arrive at the second store;
determining an estimated preparation time for preparing the pickup order;
sending a preparation instruction to the second computing device associated with the second store, the preparation instruction instructing the second store to start preparing the pickup order at least based on the estimated arrival time and the estimated preparation time;
sending a first message to the user computing device indicating that the pickup order has been relocated to the second store; and
sending a second message to the first computing device associated with the first store to cancel the pickup order.

2. The system of claim 1, the operations further comprising sending a rerouting instruction to the user computing device, the rerouting instruction indicating a route from the location associated with the customer or the pickup entity to the second store.

3. The system of claim 1, wherein the location data include at least one of a latitude associated with the user computing device, a longitude associated with the user computing device, an accuracy associated with the location data, a speed associated with the user computing device, or timestamp data associated with the location data.

4. The system of claim 1, wherein the pickup order is associated with a priority.

5. The system of claim 1, the operations further comprising updating the location data in at least one of a predetermined period of time, in real-time, or in near real-time.

6. A method comprising:
receiving a pickup order associated with a customer, the pickup order being directed to a first store;
associating the pickup order with a computing device;
determining that a location associated with the customer or a pickup entity is proximate to a second store based on location data associated with the computing device; and
in response to determining that the location associated with the customer or the pickup entity is proximate to the second store at least one of:
sending a first message to the computing device to instruct the customer or the pickup entity to travel to the first store instead of the second store; or
sending a second message to the computing device indicating that the pickup order has been relocated to the second store, and sending the pickup order to a second computing device associated with the second store.

7. The method of claim 6, wherein determining that the location associated with the customer or the pickup entity is proximate to the second store comprises determining that the location associated with the customer or the pickup entity is within a threshold distance to the second store.

8. The method of claim 6, wherein the location data include at least one of a latitude associated with the computer device, a longitude associated with the computer device, an accuracy associated with the location data, a speed associated with the computer device, or timestamp data associated with the location data.

9. The method of claim 8, wherein determining that the location associated with the customer or the pickup entity is proximate to the second store comprises determining that the speed associated with the computing device is less than a speed threshold.

10. The method of claim 6, further comprising:
sending a third message to the computing device indicating that the computing device is proximate to the second store rather than the first store; and
receiving, from the computing device, data indicative of at least one of:
a confirmation that the customer or the pickup entity will travel to the first store; or
a selection to relocate the order to the second store.

11. The method of claim 6, further comprising sending a notification to the first computing device associated with the first store to cancel or delay the pickup order.

12. The method of claim 6, further comprising sending a rerouting instruction to the computing device, the rerouting instruction indicating a route from the location associated with the customer or the pickup entity to the second store.

13. The method of claim 6, wherein the pickup order is associated with a priority, the method further comprising:
inserting the pickup order into an order queue based on the priority.

14. One or more non-transitory computer-readable media storing instructions that, when executed by one or more processors, cause one or more computing devices to perform operations comprising:
receiving a pickup order associated with a customer, the pickup order being directed to a first store;
associating the pickup order with a computing device;
determining that a location associated with the customer or a pickup entity is proximate to a second store based on location data associated with the computing device; and
in response to determining that the location associated with the customer or the pickup entity is proximate to the second store at least one of:
sending a first message to the computing device to instruct the customer or the pickup entity to travel to the first store instead of the second store; or
sending a second message to the computing device indicating that the pickup order has been relocated to the second store, and sending the pickup order to a second computing device associated with the second store.

15. The one or more non-transitory computer-readable media of claim 14, determining that the location associated with the customer or the pickup entity is proximate to the second store comprises determining that the location associated with the customer or the pickup entity is within a threshold distance to the second store.

16. The one or more non-transitory computer-readable media of claim 14, wherein the location data include at least one of a latitude associated with the computing device, a longitude associated with the computing device, an accuracy associated with the location data, a speed associated with the computing device, or timestamp data associated with the location data.

17. The one or more non-transitory computer-readable media of claim 16, wherein determining that the location associated with the customer or the pickup entity is proximate to the second store comprises determining that the speed associated with the computing device is less than a speed threshold.

18. The one or more non-transitory computer-readable media of claim 14, the operations further comprising updating the location data in at least one of a predetermined period of time, in real-time, or in near real-time.

19. The one or more non-transitory computer-readable media of claim 14, the operations further comprising:
sending a third message to the computing device indicating that the computing device is proximate to the second store rather than the first store; and
receiving, from the computing device, data indicative of at least one of:
a confirmation that the customer or the pickup entity will travel to the first store; or
a selection to relocate the order to the second store.

20. The one or more non-transitory computer-readable media of claim 14, the operations further comprising sending a rerouting instruction to the computing device, the rerouting instruction indicating a route from the location associated with the customer or the pickup entity to the second store.
